(19) United States
(12) Patent Application Publication
(10) Pub. No.: US 2008/0201667 A1
(43) Pub. Date: Aug. 21, 2008

(54) INTERACTIVE COMPUTER GRAPHICAL USER INTERFACE METHOD AND SYSTEM

(76) Inventors: Phillip M. Drayer, Dallas, TX (US); Michael M. Sroka, Dallas, TX (US)

Correspondence Address: WINSTEAD PC, P.O. BOX 50784, DALLAS, TX, 75201, US

(21) Appl. No.: 11/943,014

(22) Filed: Nov. 20, 2007

Related U.S. Application Data
(60) Provisional application No. 60/867,576, filed on Nov. 28, 2006.

(51) Int. Cl. G06F 3/048

(52) U.S. Cl. 715/854

(57) ABSTRACT

A graphical user interface includes a plurality of single-action-selectable primary navigation buttons arranged around at least a portion of a periphery of a display content window. Selection of a single-action-selectable primary navigation button of the plurality of single-action-selectable primary navigation buttons causes corresponding content to appear in the display content window. Selection of at least one of the plurality of single-action-selectable primary navigation buttons causes content available in the display content window via subsequent selection of the at least one of the plurality of single-action-selectable primary navigation buttons to change. The graphical user interface also includes at least one secondary navigation button. The at least one secondary navigation button includes at least one of a back button, a next button, and a content-window scalar button. The graphical user interface also includes at least one dynamic program button. Selection of the at least one dynamic program button causes an identifier of content selectable via at least one of the plurality of single-action-selectable primary navigation buttons to change.

### CROSS-REFERENCE TO RELATED APPLICATIONS

This patent application claims priority from, and incorporates the entire disclosure of, U.S. Patent Application No. 60/867,576, filed on Nov. 28, 2006.

### BACKGROUND

1. Technical Field

The present invention relates generally to an interactive computer graphical user interface method and system and, more particularly, but not by way of limitation, to a computer graphical user interface that, in some embodiments, permits a user to navigate without a need for scrolling down or drop-down menus.

2. History Of Related Art

The use of networked computers, for example, via the Internet, has enabled millions of users world-wide to more rapidly and easily access vast amounts of information. The amount of information available via the Internet is increasing at an exponential rate. However, one of the limitations of current systems is the way in which the information obtained by a user is made available to the user. Another limitation is related to how the user navigates, for example, via a graphical user interface (“GUI”), information available to the user.

### SUMMARY OF THE INVENTION

A graphical user interface includes a plurality of single-action-selectable primary navigation buttons arranged around at least a portion of a periphery of a display content window. Selection of a single-action-selectable primary navigation button of the plurality of single-action-selectable primary navigation buttons causes corresponding content to appear in the display content window. Selection of at least one of the plurality of single-action-selectable primary navigation buttons causes content available in the display content window via subsequent selection of the at least one of the plurality of single-action-selectable primary navigation buttons to change. The graphical user interface also includes at least one secondary navigation button. The at least one secondary navigation button includes at least one of a back button, a next button, and a content-window scalar button. The graphical user interface also includes at least one dynamic program button. Selection of the at least one dynamic program button causes an identifier of content selectable via at least one of the plurality of single-action-selectable primary navigation buttons to change.

A graphical-user-interface method includes providing a plurality of single-action-selectable primary navigation buttons arranged around at least a portion of a periphery of a display content window, receiving selection of a single-action-selectable primary navigation button of the plurality of single-action-selectable primary navigation buttons, responsive to the received selection, causing content corresponding to the selected single-action-selectable primary navigation button to appear in the display content window and causing content available in the display content window via subsequent selection of the selected single-action-selectable primary navigation buttons to change, providing at least one secondary navigation button, the at least one secondary navigation button comprising at least one of a back button, a next button, and a content-window scalar button, providing at least one dynamic program button, receiving selection of the at least one dynamic program button, and responsive to the received selection of the at least one dynamic program button, causing an identifier of content selectable via at least one of the plurality of single-action-selectable primary navigation buttons to change.

The above summary of the invention is not intended to represent each embodiment or every aspect of the present invention.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 illustrates a typical embodiment of a navigation tool;

FIG. 2 illustrates exemplary primary navigation buttons of a navigation tool;

FIG. 3 illustrates a navigation tool with a content window thereof in a virtual shopping-mall mode;

FIG. 4 illustrates a navigation tool in a news mode;

FIG. 5 illustrates a navigation tool in a splash-page mode; and

FIG. 6 illustrates an embodiment of a computer on which various embodiments of the invention may be implemented.

### DETAILED DESCRIPTION OF ILLUSTRATIVE EMBODIMENTS OF THE INVENTION

In a typical embodiment, a graphical user interface (GUI) includes a navigation tool that provides users with a simple, intuitive, and compelling experience. The GUI may include a static rectangular tabulated navigation tool that has no banner logo, column advertising, scroll-down menus, or drop-down menus. Within the rectangular navigation tool is a layered viewing screen that may include a ticker/crawl on which news or other information may be displayed. In various embodiments, content of the navigation tool may be customized by the user. Selections within the GUI may be made, for example, by the click of a mouse or use of a keyboard, voice recognition system, or other control device.

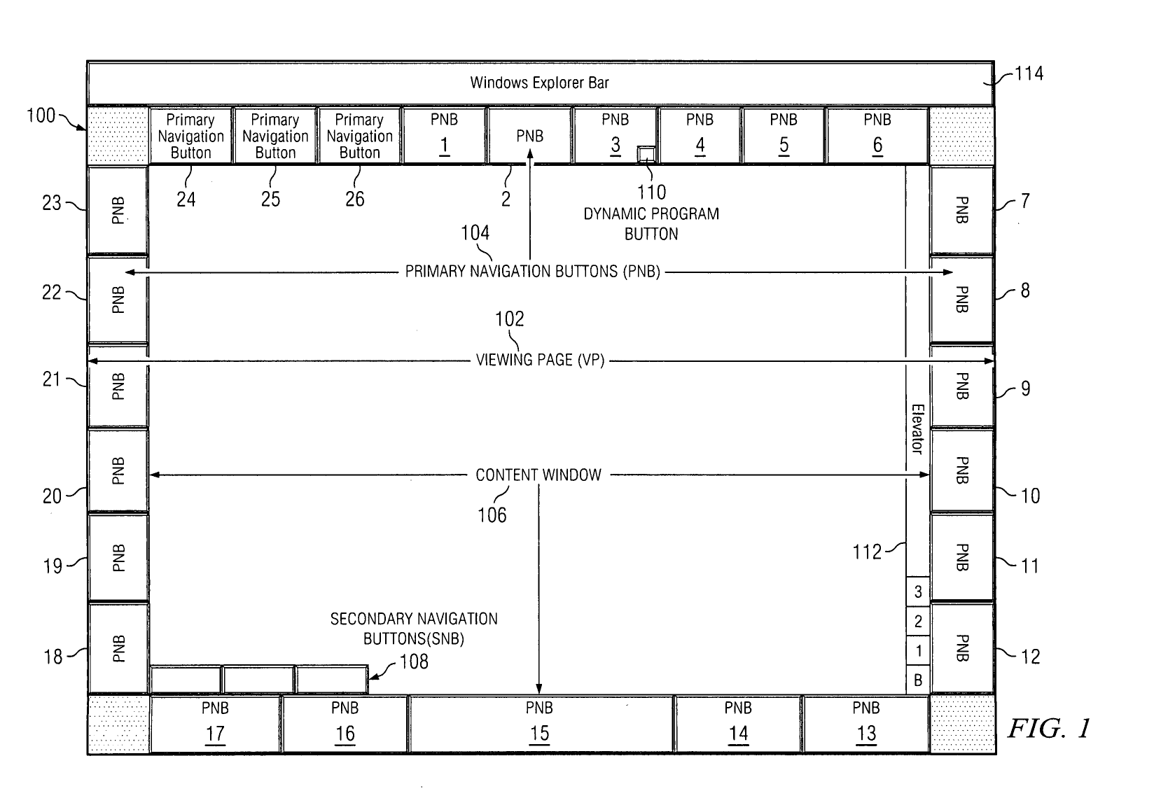

FIG. 1 illustrates a typical embodiment of a navigation tool 100. The navigation tool 100 includes a viewing page (VP) 102, a plurality of primary navigation buttons (PNBs) 104, a content window 106, a plurality of secondary navigation buttons (SNBs) 108, a dynamic program button (DPB) 110, and an elevator 112. Also illustrated as part of the navigation tool 100 is a browser navigation bar 114, illustrated in FIG. 1 as a WINDOWS EXPLORER bar. The VP 102 includes the plurality of PNBs 104, specific PNBs 104(1)-(26) being illustrated therein near the periphery of the navigation tool 100. In a typical embodiment, each of the PNBs 104 performs a unique function.

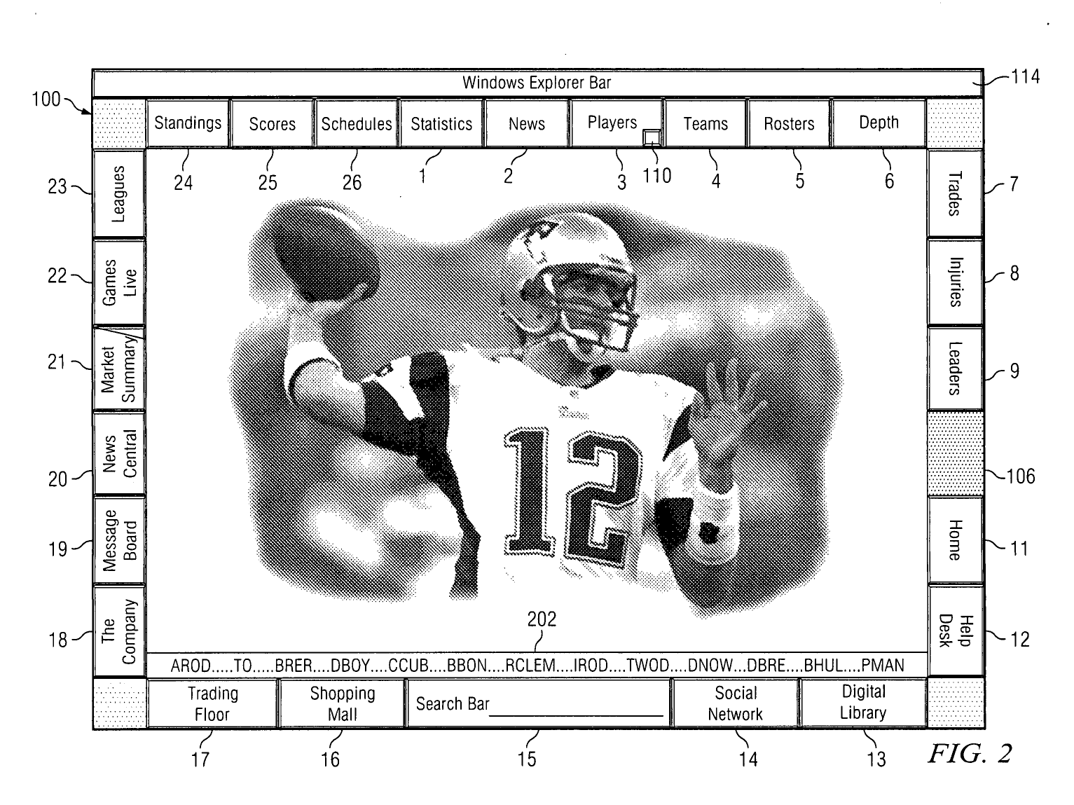

Referring now to FIG. 2, the exemplary PNBs 104(1)-(26) are illustrated as follows: a statistics PNB 104(1); a news PNB 104(2); a players PNB 104(3); a teams PNB 104(4); a rosters PNB 104(5); a depth PNB 104(6); a trades PNB 104(7); an injuries PNB 104(8); a leaders PNB 104(9); a my-account PNB 104(10); a home PNB 104(11); a help-desk PNB 104(12); a digital-library PNB 104(13); a social-network PNB 104(14); a search-bar PNB 104(15); a shopping-mall PNB 104(16); a trading-floor PNB 104(17); a “the company” PNB 104(18); a message-board PNB 104(19); a news-central PNB 104(20); a market-summary PNB 104(21); a games-live PNB 104(22); a leagues PNB 104(23); a standings PNB 104(24); a scores PNB 104(25); and a schedules PNB 104(26). By selecting one of the PNBs 104(1)-(26), the user can select content related to the PNB 104 chosen. Moreover, in a typical embodiment, the PNBs 104 may be customized so that the user can select content available via each of the PNBs 104. The PNBs 104 can be layered, meaning that at least one of the PNBs 104(1)-(26) may be adapted to permit more than one function to be accessed using the at least one of the PNBs 104(1)-(26) so adapted. In a typical embodiment, a user may cycle through different options available for one of the PNBs 104(1)-(26) by using the DPB 110.

FIG. 2 illustrates the navigation tool 100 in a state in which information relating to football is shown. From a football page such as that shown in FIG. 2, information related, for example, to baseball or soccer may be accessed by the user selecting and activating the DPB 110. Any number of different PNBs 104 can be accessed via activation of the DPB 110. In some embodiments, activation of the DPB 110 causes all of the PNBs 104(1)-(26) to change to reflect different information than that displayed prior to activation of the DPB 110. In other embodiments, one or more, but fewer than all, of the PNBs 104(1)-(26) may change responsive to activation of the DPB 110. Those having skill in the art will appreciate that the PNBs 104 may be of any size or shape and may be located in other positions on the navigation tool 100 besides those illustrated without departing from principles of the invention.

In various embodiments, each of the PNBs 104(1)-(26) may be activated by a single action, such as, for example, a single mouse click or via a tap on a touch screen. When one of the PNBs 104(1)-(26) is activated via, for example, a mouse click, corresponding content appears in the content window 106.

The secondary navigation buttons (SNBs) 108 may be of any size or shape and may be made to appear anywhere in the content window 106. In various embodiments, the SNBs 108 provide additional navigation options to the user. As illustrated, the SNBs 108 include a conventional back button, which causes previously-shown information to be displayed, as well as a Next button, and a CW scalar button. The CW scalar button causes the CW 106 as displayed to change in size.

In some embodiments, one or more of the PNBs 104 may be selected by the user and then, subsequent to the selection of the one or more PNBs 104, the DPB 110 may be activated, which causes only the previously-selected PNBs 104 to change to a next available option. Also illustrated in FIG. 2 is a ticker/crawl 202, by which current scores or other information may be continuously provided to the user.

Referring again to FIG. 1, the elevator 112 permits relatively large amounts of content to be accessed quickly. In a typical embodiment, the elevator 112 is analogous to an elevator in a bricks-and-mortar building. For example, B, 1, 2, and 3 can be thought of as representing floors in a building, such as, for example, a department store. By selecting one of B, 1, 2, or 3, content accessible on a given virtual floor may be accessed by the user. One example of an application of the elevator 112 is in the context of a virtual shopping-mall, in which case the virtual floors could represent different types of goods or services available via a virtual shopping mall.

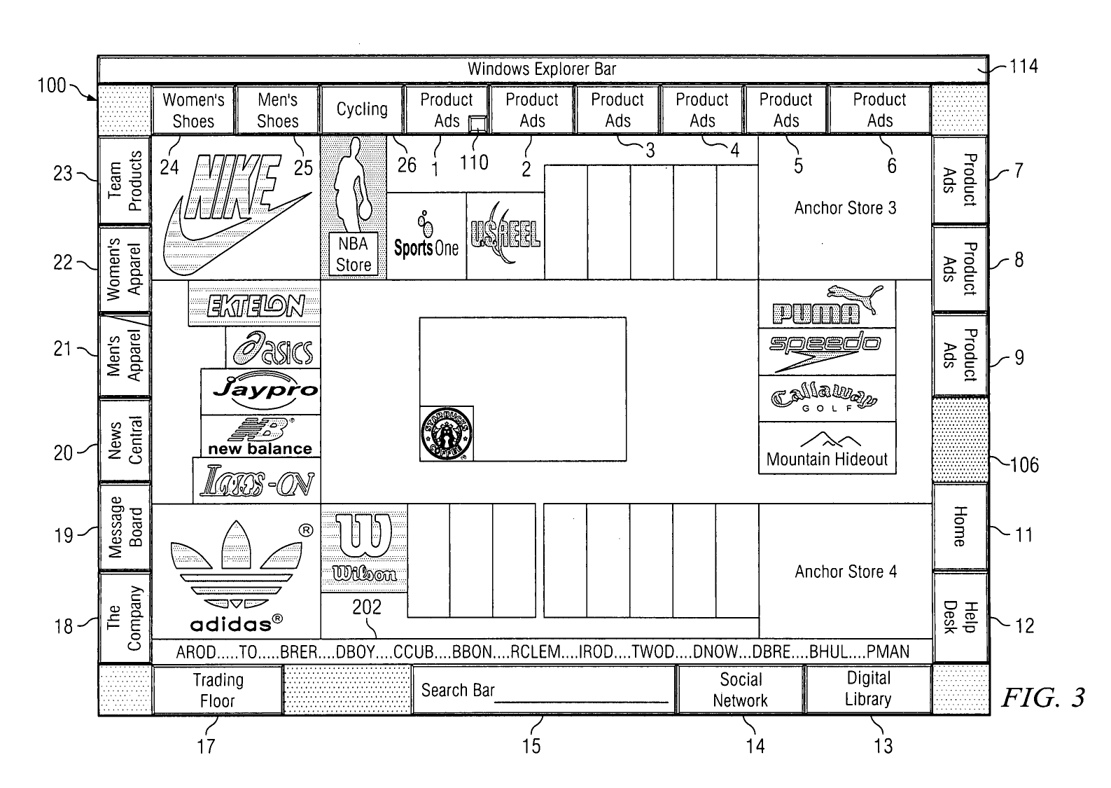

Referring now to FIG. 3, the navigation tool 100 is illustrated with the CW 106 in a virtual shopping-mall mode. In the virtual shopping-mall mode, the user may select which store of a plurality of stores the user wants to visit and potentially buy goods or services from. The virtual shopping-mall mode of the CW 106 permits different providers of goods and services to in effect rent space in the virtual shopping mall, as opposed to the user being able to access a website of the provider via a website providing the CW 106. In other words, providers of goods and services can in effect rent a virtual space in the virtual shopping mall from which goods and services may be sold; however, the user never leaves the website of the entity providing the CW 106 during a shopping experience. In the illustrative embodiment shown in FIG. 3, entities selling Nike®, Asics®, New Balance®, Adidas®, Wilson®, and Puma® products have rented space in the virtual shopping mall. In addition, the PNBs 104(1)-(26) may be used for, for example, product advertisements or other store-related information to be accessed by the user.

In some embodiments, the navigation tool 100 may be used in conjunction with a system such as those described in U.S. Provisional Application No. 60/822,819, filed Aug. 18, 2006 and U.S. Provisional Application No. 60/844,288, filed Sep. 13, 2006, each of which is directed to a method of and system for trading of synthetic ownership interests in personalities. In such systems, credits in a user's account may have been accumulated via trading of synthetic interests. The credits may be deducted from the user's account responsive to an indication from the user that the user wants to buy goods or services, for example, from the Nike® store. Responsive to an indication from the user of a desire to purchase goods or services, the user's account may be appropriately debited and an indication provided to the Nike® store to ship the goods or provide the services directly, for example, to a user's membership address on file. In such cases, no credit card fee need be paid by the Nike® store since credits in the user's account rather than an actual credit card are used to make the purchase.

In a typical embodiment, the navigation tool 100 includes no banner advertising, no company banner at the top of the VP 102, no scroll downs, and no drop-down menus. In a typical embodiment, the VP 102 is scaled to fill the entire available computer screen below the browser navigation bar 114 and nothing more.

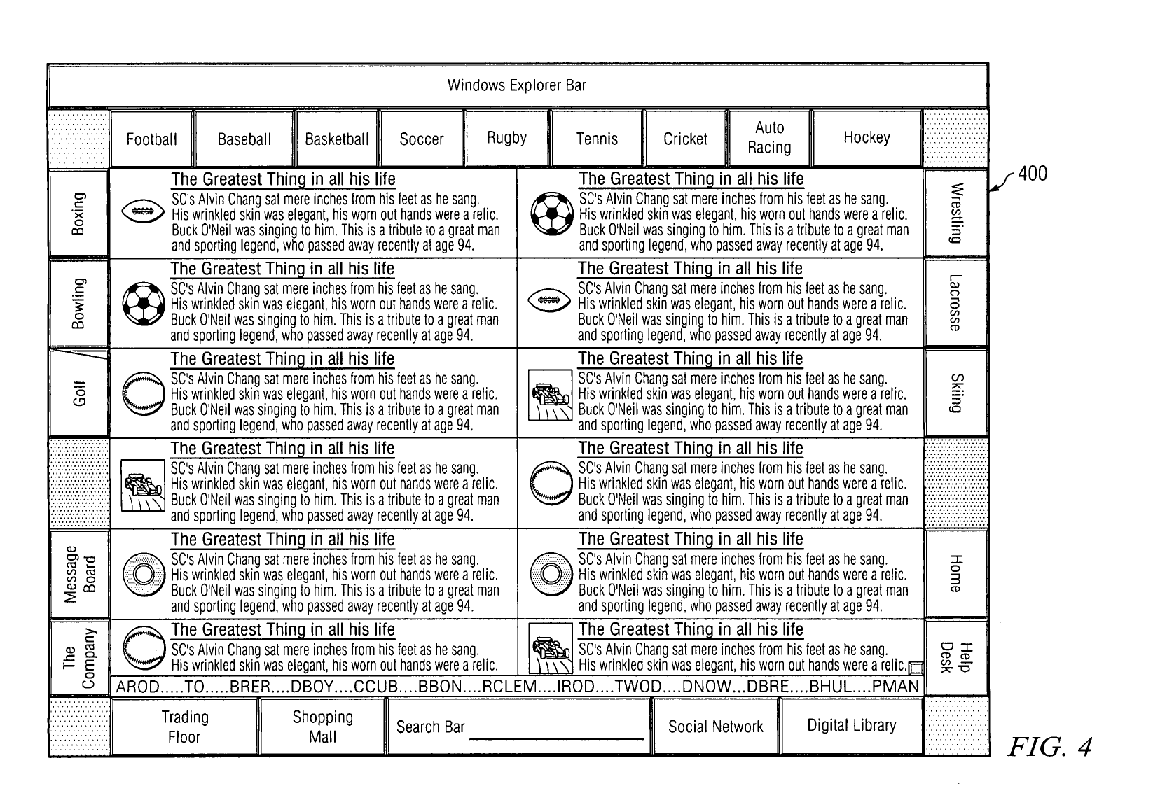

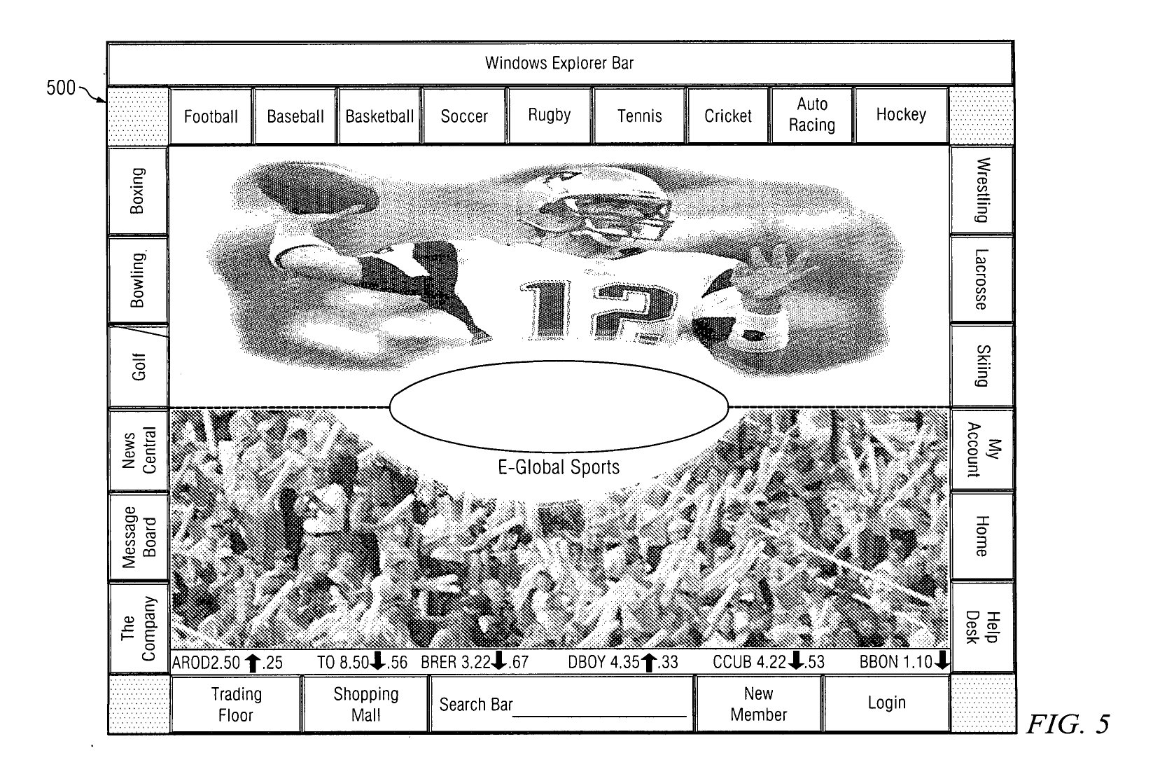

FIGS. 4-5 illustrate additional possible embodiments of the invention. FIG. 4 illustrates a news mode of a navigation tool 400, in which news articles and updates regarding various sports can be made available to a user. Operation of the navigation tool 400 is analogous to that of, for example, the navigation tool 100. FIG. 5 illustrates a navigation tool 500 in a splash-page mode. As is understood by those having skill in the art, the splash-page mode may in some embodiments, automatically move to a home page or may require the user to click through to the home page.

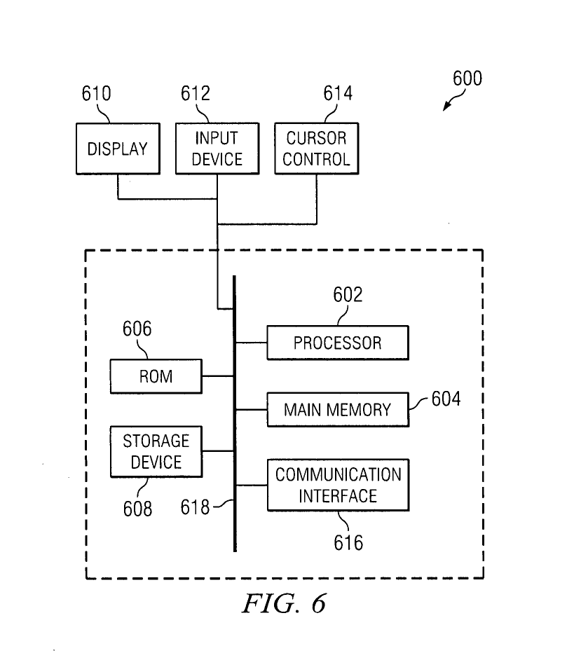

FIG. 6 illustrates an embodiment of a computer on which various embodiments of the invention may be implemented. In the implementation, a computer 600 may include a bus 618 or other communication mechanism for communicating information and a processor 602 coupled to the bus 618 for processing information. The computer 600 also includes a main memory 604, such as random access memory (RAM) or other dynamic storage device, coupled to the bus 618 for storing computer readable instructions by the processor 602.

The main memory 604 also may be used for storing temporary variables or other intermediate information during execution of the instructions to be executed by the processor 602. The computer 600 further includes a read only memory (ROM) 606 or other static storage device coupled to the bus 618 for storing static information and instructions for the processor 602. A computer readable storage device 608, such as a magnetic disk or optical disk, is coupled to the bus 618 for storing information and instructions for the processor 602. The computer 600 may be coupled via the bus 618 to a display 610, such as a liquid crystal display (LCD) or a cathode ray tube (CRT), for displaying information to a user. An input device 612, including, for example, alphanumeric and other keys, is coupled to the bus 618 for communicating information and command selections to the processor 602. Another type of user input device is a cursor control 614, such as a mouse, a trackball, or cursor direction keys for communicating direct information and command selections to the processor 602 and for controlling cursor movement on the display 610. The cursor control 614 typically has two degrees of freedom in two axes, a first axis (e.g., x) and a second axis (e.g., y), that allow the device to specify positions in a plane.

The term “computer readable instructions” as used above refers to any instructions that may be performed by the processor 602 and/or other component of the computer 600. Similarly, the term “computer readable medium” refers to any storage medium that may be used to store the computer readable instructions. Such a medium may take many forms, including, but not limited to, non volatile media, volatile media, and transmission media. Non-volatile media include, for example, optical or magnetic disks, such as the storage device 608. Volatile media include dynamic memory, such as the main memory 604. Transmission media include coaxial cables, copper wire and fiber optics, including wires of the bus 618. Transmission media can also take the form of acoustic or light waves, such as those generated during radio frequency (RF) and infrared (IR) data communications. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EPROM, any other memory chip or cartridge, a carrier wave, or any other medium from which a computer can read.

Various forms of the computer readable media may be involved in carrying one or more sequences of one or more instructions to the processor 602 for execution. For example, the instructions may initially be borne on a magnetic disk of a remote computer. The remote computer can load the instructions into its dynamic memory and send the instructions over a telephone line using a modem. A modem local to the computer 600 can receive the data on the telephone line and use an infrared transmitter to convert the data to an infrared signal. An infrared detector coupled to the bus 618 can receive the data carried in the infrared signal and place the data on the bus 618. The bus 618 carries the data to the main memory 604, from which the processor 602 retrieves and executes the instructions. The instructions received by the main memory 604 may optionally be stored on the storage device 608 either before or after execution by the processor 602.

The computer 600 may also include a communication interface 616 coupled to the bus 618. The communication interface 616 provides a two-way data communication coupling between the computer 600 and a network. For example, the communication interface 616 may be an integrated services digital network (ISDN) card or a modem used to provide a data communication connection to a corresponding type of telephone line. As another example, the communication interface 616 may be a local area network (LAN) card used to provide a data communication connection to a compatible LAN. Wireless links may also be implemented. In any such implementation, the communication interface 616 sends and receives electrical, electromagnetic, optical, or other signals that carry digital data streams representing various types of information. The storage device 608 can further include instructions for carrying out various processes for image processing as described herein when executed by the processor 602. The storage device 608 can further include a database for storing data relative to same.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

What is claimed is:

1. A graphical user interface comprising:
a plurality of single-action-selectable primary navigation buttons arranged around at least a portion of a periphery of a display content window;
wherein selection of a single-action-selectable primary navigation button of the plurality of single-action-selectable primary navigation buttons causes corresponding content to appear in the display content window;
wherein selection of at least one of the plurality of single-action-selectable primary navigation buttons causes content available in the display content window via subsequent selection of the at least one of the plurality of single-action-selectable primary navigation buttons to change;
at least one secondary navigation button, the at least one secondary navigation button comprising at least one of a back button, a next button, and a content-window scalar button;
at least one dynamic program button; and
wherein selection of the at least one dynamic program button causes an identifier of content selectable via at least one of the plurality of single-action-selectable primary navigation buttons to change.

2. The graphical user interface of claim 1, wherein selection of the at least one dynamic program button causes an identifier of content selectable via each of the plurality of single-action-selectable primary navigation buttons to change.

3. The graphical user interface of claim 1, wherein the plurality of single-action-selectable primary navigation buttons are arranged around the periphery of the display content window.

4. The graphical user interface of claim 1, wherein operation of the graphical user interface excludes drop-down and scrolling functionality.

5. The graphical user interface of claim 1, wherein the at least one secondary navigation button is located within the display content window.

6. The graphical user interface of claim 1, wherein the single action is selected from the group consisting of a mouse click, activation of a touch screen, and a voice command.

7. The graphical user interface of claim 1, wherein selection of the at least one dynamic program button causes an identifier of content selectable via a previously-selected single-action-selectable primary navigation button of the plurality of single-action-selectable primary navigation buttons to change.

8. The graphical user interface of claim 1, further comprising a ticker/crawl display.

9. The graphical user interface of claim 1, further comprising a browser navigation bar.

10. The graphical user interface of claim 1, wherein the graphical user interface excludes banner advertising.

11. A graphical-user-interface method comprising:
providing a plurality of single-action-selectable primary navigation buttons arranged around at least a portion of a periphery of a display content window;
receiving selection of a single-action-selectable primary navigation button of the plurality of single-action-selectable primary navigation buttons;
responsive to the received selection:
causing content corresponding to the selected single-action-selectable primary navigation button to appear in the display content window; and
causing content available in the display content window via subsequent selection of the selected single-action-selectable primary navigation buttons to change;
providing at least one secondary navigation button, the at least one secondary navigation button comprising at least one of a back button, a next button, and a content-window scalar button;
providing at least one dynamic program button;
receiving selection of the at least one dynamic program button; and
responsive to the received selection of the at least one dynamic program button, causing an identifier of content selectable via at least one of the plurality of single-action-selectable primary navigation buttons to change.

12. The graphical-user-interface method of claim 11, wherein selection of the at least one dynamic program button causes an identifier of content selectable via each of the plurality of single-action-selectable primary navigation buttons to change.

13. The graphical-user-interface method of claim 11, wherein the plurality of single-action-selectable primary navigation buttons are arranged around the periphery of the display content window.

14. The graphical-user-interface method of claim 11, wherein operation of the graphical-user-interface excludes drop-down and scrolling functionality.

15. The graphical-user-interface method of claim 11, wherein the at least one secondary navigation button is located within the display content window.

16. The graphical-user-interface method of claim 11, wherein the single action is selected from the group consisting of a mouse click, activation of a touch screen, and a voice command.

17. The graphical-user-interface method of claim 11, wherein selection of the at least one dynamic program button causes an identifier of content selectable via a previously-selected single-action-selectable primary navigation button of the plurality of single-action-selectable primary navigation buttons to change.

18. The graphical-user-interface method of claim 11, wherein the steps are performed in the order listed.
